(19) United States
(12) Patent Application Publication
(10) Pub. No.: US 2003/0185182 A1
(43) Pub. Date: Oct. 2, 2003

(54) System and method for providing universal mobile device access to information

(76) Inventors: Gary Young, Knoxville, TN (US); Andrew Malek, Knoxville, TN (US); Mark Martin, Oneida, TN (US); Zbigniew Czyzewski, Knoxville, TN (US); Stephen Nobert, Knoxville, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/099,037

(22) Filed: Mar. 15, 2002

Related U.S. Application Data
(60) Provisional application No. 60/308,236, filed on Jul. 27, 2001.

(51) Int. Cl. H04Q 7/24

(52) U.S. Cl. 370/338; 370/349

(57) ABSTRACT

A system and method for providing universal mobile device access to information without requiring separate applications for each requesting mobile device. Generally, the system comprises an enterprise backend having the requested information stored therein. The system also comprises a universal server connected to the enterprise backend for receiving a request for the information from the mobile device, and for providing the mobile device with the information from the enterprise backend. The universal server does not require separate software applications to customize display of the information for each different category of mobile device requesting information.

### CROSS-REFERENCE TO RELATED APPLICATIONS

This application claims the benefit of the U.S. provisional application having serial No. 60/308,236, filed on Aug. 27, 2001, and entitled “System and Method for Improving Transition for Wireless Communication,” which is incorporated by reference herein in its entirety.

### FIELD OF THE INVENTION

The present invention generally relates to wireless communication and, more particularly, is related to a system and method for providing mobile devices with access to information via a universal application.

### BACKGROUND OF THE INVENTION

Advancements in technology have led to the production and availability of a wide array of mobile devices. The availability of these devices has essentially transformed methods of communication and information retrieval. Mobile devices have contributed heavily to advancements in the telecommunication field and have also added an element of convenience to every day life. No longer is it required for an individual to transmit and receive information via a stationary unit. In fact, the production and availability of mobile devices has resulted in mobile devices changing from a luxury item, to an item of necessity.

The current landscape of wireless communication includes a multitude of wireless communication services based on different technologies and offering different features to mobile device users. For instance, analog advanced mobile phone services (AMPS), which were implemented in the 1980s, provide basic calling and voice mail. Digital advanced mobile phone service (D-AMPS) provides advanced features such as caller identification and paging. D-AMPS uses multiplexing techniques such as time division multiple access (TDMA) and code division multiple access (CDMA) to give wireless carriers increased capacity on existing channels. Other services, such as global system for mobile communications (GSM) and personal communications service (PCS), offer similar features.

More advanced wireless communication services, such as cellular digital packet data (CDPD), specialized mobile radio (SMR), wideband CDMA (WCDMA), general packet radio service (GPRS), services based on wireless access protocol (WAP), Internet protocol (IP), file transfer protocol (FTP), hyper text transfer protocol (HTTP) and other known data communication protocols, and other “second generation” (2G) and “third generation” (3G) services, provide numerous types of wireless data communication services. For example, these advanced wireless data communication services enable mobile device users to access data from numerous sources via public or private packet-switched networks or other data networks including the Internet, circuit switched networks such as the public switched telephone network, or other wireless networks.

With the number of available mobile devices increasing daily, dynamic applications required to enable use and performance of mobile devices also require development. Of particular interest are wireless devices such as, but not limited to, mobile phones, cellular phones, pagers, personal digital assistants (PDAs), and other hand held devices. These wireless devices require interactive and dynamic applications that are, in most cases, particular to a specific wireless device, and which provide functionality to allow access to requested information and services.

Applications that provide wireless device functionality define a large number of necessary functions. Wireless device functions provided by dynamic applications include, but are not limited to, user identity recognition, enabling data to be retrieved from a specific source, and formatting of requested data for transmission to a requesting wireless device. Unfortunately, due to different demands for each wireless device, separate customized applications are required for each different wireless device. Typically, customized applications are created in software. The necessity of separate software applications for each different category of wireless device contributes to wireless device cost. In other words, since a single software application is not universally used by all wireless devices, the cost of developing separate applications to accommodate for providing features such as, but not limited to, retrieval of data in response to a user request, is incorporated into the cost of wireless devices.

To address the above mentioned, programmers have been working to develop industry wide standards that will be used by all wireless device manufacturers for developing applications over wireless communication networks. The wireless markup language (WML) is an example of such an application. WML is a markup language based on the extensible markup language (XML), and is intended for use in specifying content and user interfaces for narrowband devices, including cellular phones and pagers.

Unfortunately, WML does not render the same on all wireless devices. Each wireless device potentially has different display characteristics and may use one, or a variety of microbrowsers, wherein each microbrowser has the possibility of rendering WML slightly different. Therefore, it is desirable to optimize content for mobile devices so the content may be rendered in an optimal fashion on each mobile device.

### SUMMARY OF THE INVENTION

In light of the foregoing, the preferred embodiment of the present invention generally relates to a system for providing a universal system and application that will allow any mobile device to access and receive requested information in a format specific to the category of the requesting mobile device without requiring separate software applications to identify display criteria for each different category of mobile device.

Generally, with reference to the structure of the access system, the system utilizes an enterprise backend having the requested information stored therein. The system also comprises a universal server connected to the enterprise backend for receiving a request for the information from the mobile device, and for providing the mobile device with the information from the enterprise backend. The universal server does not require separate software applications to customize display of the information for each different category of mobile device requesting information.

The present invention can also be viewed as providing a method for providing universal mobile device access to information. In this regard, the method can be broadly summarized by the following steps: receiving a request for information from a mobile device; and providing the mobile device with the information, wherein the providing of the information does not require separate software applications for each different category of mobile device requesting the information, to customize the display of the information on the requesting mobile device.

Other systems and methods of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components of the drawings are not necessarily to scale, emphasis instead being placed upon clearly illustrating the principles of the present invention. Moreover, in the drawings, like referenced numerals designate corresponding parts throughout the several views.

FIG. 1 is a block diagram illustrating a typical mobile communication system in which the present access system may be implemented.

FIG. 2 is a block diagram illustrating an improved mobile communication system comprising a universal server that addresses the need for separate software applications for each different category of mobile communication device.

FIG. 3 is a block diagram further illustrating the universal server of FIG. 2.

FIG. 4 is a block diagram providing an example of the device manager of FIG. 3.

FIG. 5 illustrates rendering of a menu on a mobile phone via use of the <list> tag.

FIG. 6 illustrates rendering of the menu of FIG. 5 on a computer screen, such as, but not limited to, a laptop, via use of the <list> tag.

### DETAILED DESCRIPTION

The access system of the present invention can be implemented in software, firmware, hardware, or a combination thereof. In the preferred embodiment of the invention, which is intended to be a non-limiting example, a portion of the system is implemented in software that is executed by a universal server. It should be noted that alternatively, the entire system may be provided via hardware.

The software based portion of the access system, which comprises an ordered listing of executable instructions for implementing logical functions, can be embodied in any computer-readable medium for use by, or in connection with, an instruction execution system, apparatus, or device such as a computer-based system processor containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device.

The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

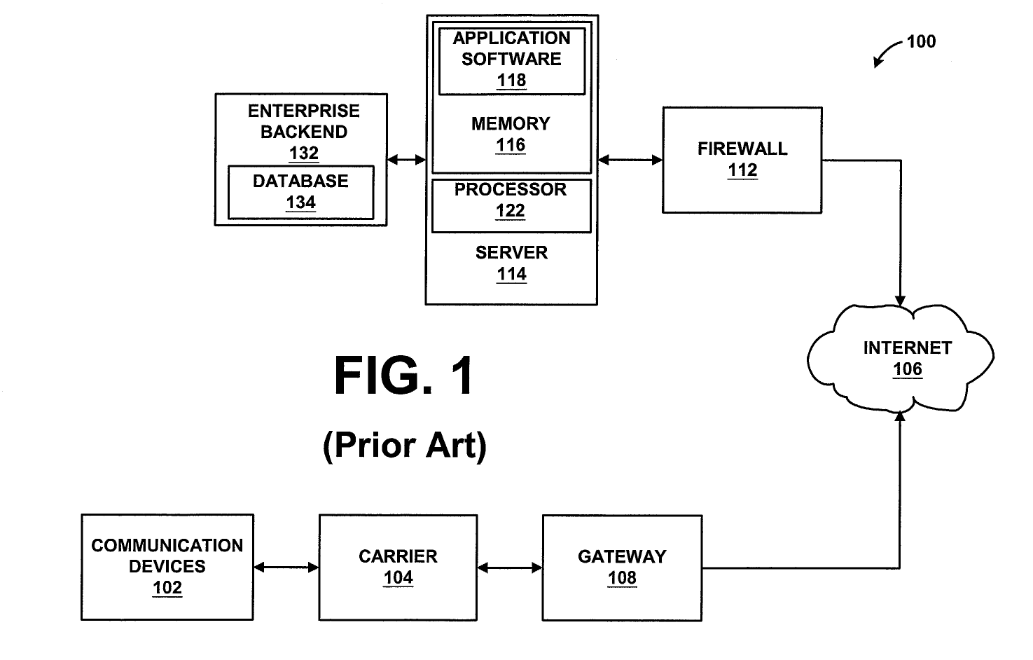

While the following description refers to wireless devices, it should be noted that the present access system may be utilized with reference to any mobile device. Referring now to the drawings, wherein like reference numerals designate corresponding parts throughout the drawings, FIG. 1 is a block diagram illustrating a typical mobile communication system 100 in which the present access system may be implemented.

Different mobile communication devices 102 may be included within the mobile communication system 100 including, but not limited to, wireless phones, cellular phones, pagers, personal digital assistants (PDAs), and other hand held devices. As is shown by FIG. 1, the Internet 106 is used to provide the mobile communication devices 102 with access to a destination for retrieval of requested information. The procedure of information retrieval is described in more detail hereinbelow.

A carrier 104 is located within the mobile communication system 100. The carrier 104 provides a point to point channel that allows mobile devices 102 to connect to the Internet 106. As is known by those skilled in the art, carriers provide a communication mechanism for analog and/or digital signals to be transmitted over a single line or media. This communication process, otherwise referred to as multiplexing, may be performed in numerous different ways. Examples of multiplexing include, but are not limited to: frequency division multiplexing (FDM), wherein each signal is assigned a different frequency; and, time division multiplexing (TDM), wherein each signal is assigned a fixed time slot in a fixed rotation.

An example of a carrier may include, but is not limited to, a T-1 carrier, which is a dedicated phone connection supporting data rates of up to 1.544 Mbps. As is known in the art, T-1 lines are popular leased line options for businesses that wish to connect to the Internet and for Internet service providers that wish to connect to an Internet backbone. Another example of a carrier may be T-3 carrier, which is a dedicated phone connection supporting data rates of up to 43 Mbps. As is known in the art, T-3 lines comprise 672 individual channels, each of which supports 64 Kbps. T-3 lines are primarily used by Internet service providers connecting to the Internet backbone.

A carrier may be configured to accommodate the WML. Specifically, the carrier may comprise a WAP gateway that allows WML pages to be displayed over the network to which the carrier is connected. As stated within the background of the invention, WML is a markup language based on XML, and is intended for use in specifying content and user interfaces for narrowband devices, including cellular phones and pagers.

A gateway 108 may be located between the carrier 104 and the Internet 106, depending upon the type of communication device 102 being accommodated for by the mobile communication system 100. The gateway 108 may be required for purposes of transforming a signal transmitted by the mobile communication device 102 to a protocol that may be utilized to provide communication over the Internet 106. Such a protocol may include, but is not limited to, the hypertext transfer protocol (http) which is the underlying protocol used by the World Wide Web (WWW).

A firewall device 112 may optionally be provided after the Internet 106 in transmission of the information request to a destination. Specifically, the firewall device 112 is utilized to prevent unauthorized access to or from the destination. Firewalls can be implemented in both hardware and software, or in a combination of both. Firewalls are frequently used to prevent unauthorized Internet users from accessing private networks connected to the Internet, especially Intranets. Messages entering or leaving the Intranet pass through the firewall device, wherein the firewall device examines each message and blocks messages that do not meet specified security criteria.

A server 114 is connected to the firewall device 112, although it should be noted that a firewall device 112 might not be utilized. A memory 116 is typically located within the server 114 for storing application software 118 that is executed by a processor 122. The server 114 typically stores applications (software 118) that provide specific mobile device functionality. As mentioned hereinabove, the mobile device functionality may include, but is not limited to, user identity recognition, enabling data to be retrieved from a specific source, and formatting of requested data for transmission to a requesting mobile communication device 102. Unfortunately, due to differing demands for each mobile communication device 102, separate customized applications are required for each different mobile communication device 102. In fact, it may even be necessary for separate servers 114 to be utilized for separate mobile communication devices 102.

An example of a server 114 that may be utilized is a Web server. Web servers allow a user to serve content over the Internet 106 using the Hypertext Markup Language (HTML). The Web server accepts requests from browsers such as, but not limited to, Netscape® and Internet Explorer®, and then returns the appropriate HTML documents. A number of server-side technologies can be used to increase the power of the server 114 beyond its ability to deliver standard HTML pages; these include common gateway interface (CGI) scripts, server-side includes, secure sockets layer (SSL) security, and active server pages (ASPs).

Another example of a server 114 may be an application server. An application server is a program that handles application operations between users and organization backend business applications or databases. Typically, application servers are used for complex transaction-based applications.

The server 114 typically comprises a memory 116 having application software 118 stored therein. The application software 118 provides functionality for performance of information requests. However, the application software 118 is specific to one category of mobile communication device 102, and therefore, is replaced for each different category of mobile communication device 102. The processor 122 is also provided within the server 114 for performing functions identified by the memory 116.

Information to be retrieved by the server 114 is typically stored at an enterprise backend 132. Specifically, the information is stored within a database 134 located within the enterprise backend 132. Therefore, the server 114 is capable of retrieving requested information from the database 134 for transmission to a requesting mobile communication device 102.

Therefore, as shown hereinabove, prior art communication systems 100 lend themselves to requiring separate servers 114, and/or separate software applications 118 for each different type of mobile communication device 102. This requirement increases the cost of mobile communication devices 102 since application and server cost is typically incorporated into device 102 cost.

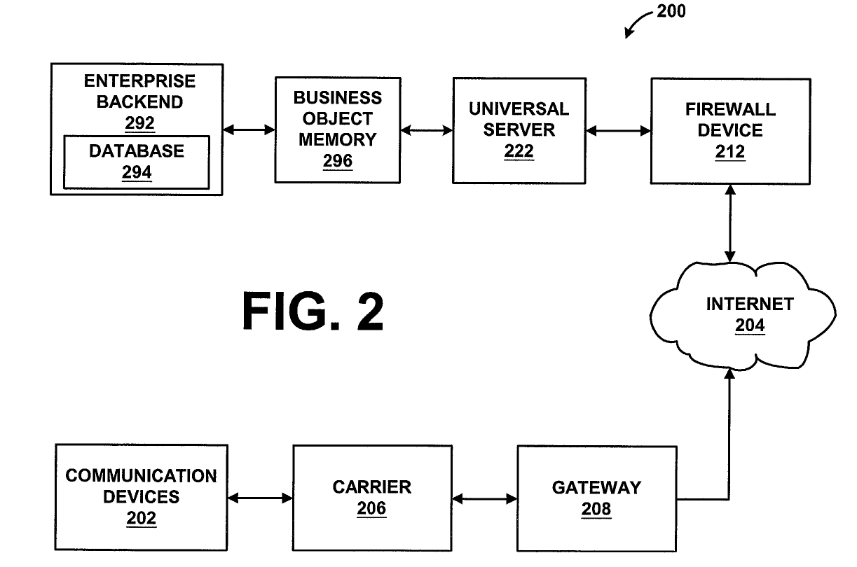

FIG. 2 is a block diagram illustrating an improved mobile communication system 200 in accordance with the preferred embodiment of the invention. The mobile communication system 200 comprises a universal server 222 that addresses the need for separate software applications for each different category of mobile communication device 202. Different mobile communication devices 202 may be included within the mobile communication system 200 including, but not limited to, wireless phones, cellular phones, pagers, personal digital assistants (PDAs), and other hand held devices. As is shown by FIG. 2, the Internet 204 is used to provide the communication devices 202 with access to a destination, which is an enterprise backend 292 in FIG. 2, for retrieval of requested information. The access procedure is described in more detail hereinbelow. It should be noted herein that the Internet 204 may instead be an Intranet in accordance with an alternate embodiment of the invention.

A carrier 206 is located within the improved mobile communication system 200. The carrier 206 provides a point to point channel to allow mobile communication devices 202 to connect to the Internet 204. A gateway 208 may be located between the carrier 206 and the Internet 204, depending upon the type of mobile communication devices 202 being accommodated for by the mobile communication system 200. The gateway 208 may be required for purposes of transforming a signal transmitted by the mobile communication device 202 to a protocol that may be utilized to provide communication over the Internet 204. Such a protocol may include, but is not limited to, HTTP, which is the underlying protocol used by the WWW. It should be noted that certain carriers do not require a gateway, and therefore, a gateway may not be located within the mobile communication system 200.

A firewall device 212 may optionally be provided after the Internet 204 in the transmission path to the enterprise backend 292. Specifically, the firewall device 212 is utilized to prevent unauthorized access to or from the destination (i.e., enterprise backend 292). The firewall device 212 is connected to a universal server 222 that is capable of accommodating for a request provided by a mobile communication device 202, without the necessity of utilizing different software applications for each different class, or category of mobile communication device 202. The universal server 222 and its components are discussed in further detail hereinbelow.

The universal server 222 is also connected to an enterprise backend 292. Connection between the universal server 222 and the enterprise backend 292 may be provided via a direct connection, the Internet, a local area network, or any other means of communication. The enterprise backend 292 is a source of information that is requested by a user of the mobile communication device 202. Specifically, the enterprise backend 292 may comprise a database 294 for storing information that may be requested by the device 202. Examples of an enterprise backend 292 may include, but are not limited to, a local area network or a wide area network.

A business object memory 296 may be located within the mobile communication system 200. The business object memory 296 defines a manner of retrieving requested information from the enterprise backend 292 and therefore, is typically defined by the owner of the enterprise backend 292. Therefore, the business object memory 296 comprises a series of defined paths that are to be taken for the retrieval of specific information. As an example, customer specific data from a backend database belonging to the customer needs to be accessed, transformed, and rendered to a mobile device requesting information located within the backend database 294. In these circumstances, a business object would contain appropriate business logic to access the customer database and extract the needed information data to be displayed at the mobile device.

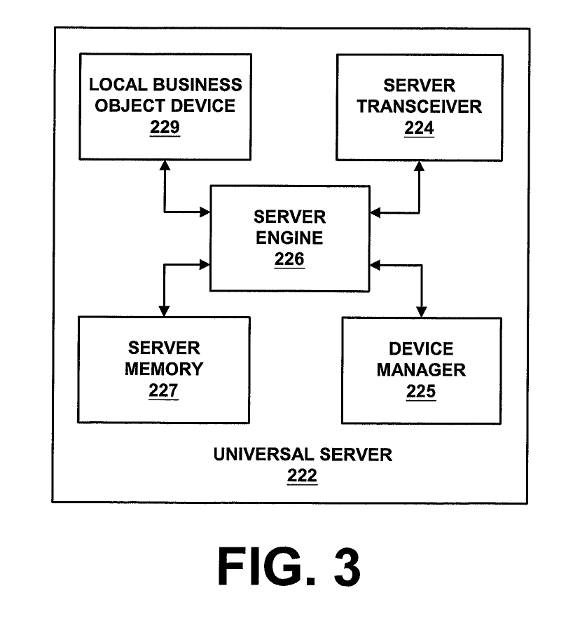

FIG. 3 is a block diagram further illustrating the universal server 222 of FIG. 2. As is shown by FIG. 3, a server transceiver 224 is located within the universal server 222, which is connected to the firewall device 212 (FIG. 2). The server transceiver 224 may be any device that provides the universal server 222 with the capability of communicating with a mobile communication device 202. As an example, the server transceiver 224 may be a Web server. As is known by those of ordinary skill in the art, a Web server is a computer or software program that, using a client/server model and the World Wide Web HTTP, serves files that form Web pages to a requesting user of a system that utilizes the Web server.

The server transceiver 224 is also capable of determining the type of communication device 202 that has transmitted the request for information. The determination of the type of communication device is performed via use of a library of categories of mobile devices that is stored within a device manager 225. Preferably, the library is stored within a database that is located within the device manager 225, although the database may be stored elsewhere.

The device manager 225 also has stored therein, individual lists of properties associated with each individual category of mobile communication device 202. The properties stored within each category vary in accordance with the category of mobile communication device 202 to which the properties relate. Examples of properties may include, but are not limited to, information regarding a type of screen utilized by the wireless communication device 202, the size of the screen, the refresh rate of the screen, redirecting instructions for situations where information is not located in a location searched, and allowable font sizes for display of requested information, and number and types of soft keys for each device. The grouping of a category and properties that pertain to that category is referred to hereinafter as a style sheet.

The server transceiver 224 receives a request for information that is derived from the mobile communication device 202 and transmits the request to a server engine 226. The server engine 226 then requests information from a style sheet located within the device manager 225 as is described hereinbelow.

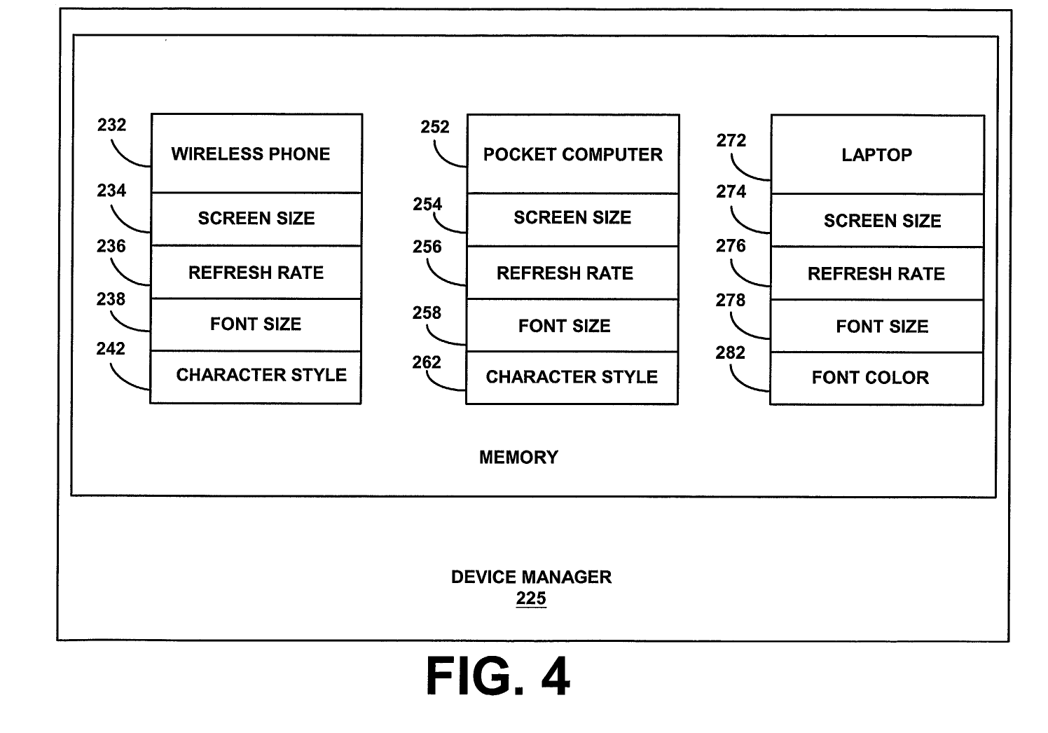

FIG. 4 is a block diagram providing an example of the device manager 225 of FIG. 3. FIG. 4 illustrates three different style sheet configurations, wherein each style sheet comprises one category and four properties. A first category of mobile communication device 202 is a wireless phone category 232. The wireless phone category 232 comprises: a screen size property 234; a refresh rate property 236; a font size property 238; and a character style property 242. A second category of mobile communication device 202 is a pocket computer category 252. The pocket computer category 252 comprises: a screen size property 254; a refresh rate property 256; a font size property 258; and a character style property 262. A third category of mobile communication device 202 is a laptop category 272. The laptop category 272 comprises: a screen size property 274; a refresh rate property 276; a font size property 278; and a font color property 282.

Determination of the category of mobile communication device 202 may be performed numerous ways. Preferably, a data packet received from the mobile communication device 202 comprises a header having information therein that identifies the category of mobile communication device. Typical header extraction techniques may be utilized to extract information regarding the source of the data packet, namely, the category of mobile communication device 202.

Based upon the identified category of the wireless communication device 202, a specific number of properties are requested by the server engine 226 to fulfill a request for information. As mentioned hereinabove, the number and type of properties requested by the server engine 226 are based upon the category of the mobile communication device 202. Information associated with the properties may be retrieved from the enterprise backend 292, or specifically, from the database 294 located within the enterprise backend 292. The format and arrangement of the information received by the server engine 226, from the enterprise backend 292, may be determined by the header associated with the received information request.

Mobile application markup language (MAML) is utilized by the server engine 226 to format and arrange the received information from the enterprise backend 292 for display by the requesting mobile communication device 202. Preferably, MAML is stored within a server memory 227 located within the universal server 222, as software. MAML pages are pre-defined within the server memory 227 that are utilized by the universal server 222 in response to a request for information. The number of MAML pages defined within the server memory 227 is determined by the number of different layouts utilized by the wireless communication device 202 for information rendering to a user of the device 202.

Use of the device manager 225, enterprise backend 292 and the server memory 227 allows for the retrieval of requested information, formatting of the information for the category of requesting mobile communication device 202, and presentation of the information in accordance with a predefined layout. The creation of MAML files that allow for proper presentation of requested information comprises device-independent code that may be rendered to a variety of different mobile communication devices 202. Further description of MAML is provided hereinbelow with reference to the MAML file structure and meta-language used to create the MAML.

A local business object device 229 is located within the universal server 222 for identifying the appropriate business object memory 296 to connect to for purposes of guiding the retrieval of requested information. The local business object 229 may comprise a memory and a processor (not shown). The memory of the local business object 229 may store identifications of different business object memories 296 that are associated with individual enterprise backends 292. Therefore, the local business object device 229 is capable of receiving the identification of a specific enterprise backend 292, in which requested information is stored, from the server engine 226. In response, the local business object device 229 attempts to retrieve the requested information from the enterprise backend 292 by first communicating with a known associated business object memory 296. The business object memory 296 may then direct the retrieval of the requested information from the enterprise backend 292.

In accordance with the aforementioned, the owner of the enterprise backend 292 may continue to utilize their current business object memory 296 instead of changing the business object memory 296 to compensate for each category of mobile communication device 202 that may need locally stored information. Instead, the local business object device 229 stores the identification of different enterprise backends 292, while additional style sheets are added to the device manager 225 to accommodate for additional mobile communication devices 202 that may utilize the universal server 222.

The following provides a detailed description of the MAML file structure and language used to create the MAML. Specifically, the following provides tags supported by MAML and examples illustrating their use.

Tag: <a>

The <a> tag supports the creation of hyperlinks in a document as well as creation of anchors to which documents can link. Hyperlinks can be to anchors in the current file, to other MAML files, to anchors in other MAML files, to pages in the same MAML file, to pages in other MAML files, and to external sites or resources. The form of the <a> tag is provided below.

<a (href=“URL”|name=“anchor name|page name”){ext=“true}>

Attributes of the <a> tag comprise an href attribute, a name attribute, and an ext attribute. The href attribute refers to a URL to which the hyperlink will link. The link may be to a MAML file, Web address, file, image, etc. If the URL contains a pound symbol (#) and then an anchor name or page ID, the hyperlink attempts to link directly to text near the anchor name or page ID in said URL. If the URL just contains a pound symbol and an anchor name or page ID, the hyperlink attempts to link to the specified anchor name or page ID in the current MAML file.

The name attribute, alternatively, provides the <a> element with an anchor name. By creating an anchor, the current MAML file or other MAML files on the Internet can link directly to the anchor. This attribute does not work on every device. In fact, some WML devices do not recognize the <a name=“ . . . ”> form of the <a> tag. These devices simply ignore such <a> tags. Jumping between pages will still work, however, using the <a href=“#pageid”> and <a href=“page.maml#pageid”> forms of the <a> tag.

The ext attribute is optional and determines whether or not the hyperlink is to a MAML file on the current universal server 222, or to a file on another server. This attribute is set to true if the destination of the link is another Web server. By default, this attribute is set to false. Text or images contained between the opening <a> tag and the closing </a> tag is displayed as the hyperlink description.

The following provides examples of use of the <a> tag. Example 1 displays a line of text followed by a hyperlink to a MAML file called file2.maml.

### EXAMPLE 1

<p> I am linking to another BlueMoon file.
<a href=“file2.maml”>File 2</a>
</p>

Example 2 displays a line of text followed by a hyperlink that would take the user back to the top of the current MAML file.

### EXAMPLE 2

<p><a name=“top”>Hello!</a>
<a href=“#top”>Link to the top of this MAML file.</a>
</p>

Example 3 displays two pages, wherein both pages display a line of text followed by a hyperlink to the other page in the current MAML file.

### EXAMPLE 3

<page id=“page1” title=“Page 1”>
<p>Hello! This is page 1.</p>
<p><a href=“#page2”>Go to page 2.</a></p>
</page>
<page id=“page2” title=“Page 2”>
<p>Hello! This is page 2.</p>
<p><a href=“#page1”>Go back to page 1.</a></p>
</page>

Tag: <br>

The <br> tag inserts a line break in the current MAML file. Most of the time, the <br> tag is a self-closing tag and is written as such: <br />. The <br> tag, however, has one attribute that some browsers support, namely, <br clear=“all”>.

The clear attribute has one valid value: “all”. This signifies that not only should a line break be inserted into the current MAML file, if any images are displayed that are aligned outside of the text, the line break should force the next line of text to be underneath the flushed-align image.

The following example utilizes the <br> and illustrates the line break by displaying a line of text followed by a line of text on the next line.

### EXAMPLE 1

Here is some text.

<br/>

Now this text is displayed on a second line

Tag: <button>

The <button> tag allows the user to submit form data or reset the form by clearing out all user-input (the ‘reset’ feature is only available on certain devices including HTML-based devices; other devices simply ignore such buttons). The <button> tag also allows mobile phone soft keys to perform desired tasks. The form of the <button> tag follows.

<button type=“submit|reset” caption=“textcaption”>

The “type” attribute is required and signifies the type of button that is to be rendered. A submit button is one where users can click on a button to submit the value of the form. Alternatively, a reset button is one where users can click on a button to clear their inputted form values and start over. Some WML-based devices will ignore rendering buttons whose type is not submit.

The “caption” attribute is also required and is the text that will be displayed on the button. Normally this is something to the effect of “Submit!” or “Reset,” depending on the button type.

The following example, when placed inside of a <form> tag (described hereinbelow), renders two buttons on HTML-based devices. The first button, labeled “Submit!”, submits the user-inputted form data. The second button, labeled “Clear Form Input,” clears the values the user selected or typed in a form. WML-based devices renders the button labeled “Submit!”

### EXAMPLE 1

<button type=“submit” caption=“Submit!” />
<button type=“reset” caption=“Clear Form Input” />

To redefine soft keys, the <button> tag is used outside of forms and placed inside a <page> tag (described hereinbelow). For this purpose, the syntax of the <button> tag is as is shown below by example 2.

### EXAMPLE 2

<button type=“soft1 | soft2” caption=“textcaption”>
softkey text and action....
</button>

The required “type” attribute determines the soft key to which an action will be defined. The value can either be soft1 or soft2, referring to the first or second soft key, respectively. In addition, the required “caption” attribute is the text that will be displayed on the soft key button. Normally this is something to the effect of “Submit” or “Reset,” depending on the button type.

Inside the <button> and </button> tags the soft key action should be defined, usually a hyperlink with associated <postvar> tags (further discussed herinbelow) to send attributes along with the links. The following illustrated example 3 shows the differences in the syntax of the <a> and <postvar> tags. In this example, the <a> tag is self-closing and does not have a description. Also, <postvar> tags are normally located between <a> and </a> tags. For soft keys, <postvar> tags should be nested inside the <button> and </button> tags. It should be noted that voice devices typically ignore the <button> tag.

### EXAMPLE 3

<page id=“sk” title=“Softkey test”>

This is a second softkey.
<button type=“soft2” caption=“Home”>

<a href=“index.maml” />
<postvar name=“logout” value=“true” />

</button>

Tag: <call>

The <call> tag renders a captioned link that, when pressed, initiates a phone call to the desired number. Devices not supporting phone calls will simply render the caption and phone number in parenthesis. The form of the <call> tag is as follows.

<call number=“phone_number” caption=“link_caption”>

The “number” attribute is required and specifies the number that should be called when this link is clicked. This value can contain any valid phone number with or without dashes. In addition, the “caption” attribute is required and specifies the caption that will be displayed for the phone hyperlink.

The following example renders a hyperlink labeled “Airtuit.” When clicked, the device initiates a phone call to “1-865-673-9600.” Other devices such as WAP phones, PDA's and other browser enabled devices simply display “Airtuit (1-865-673-9600)” or a similar message.

### EXAMPLE 1

<call number=“1-865-673-9600” caption=“Airtuit” retry=“1”>

Tag: <Comment>

The <comment> tag allows MAML writers to insert comments inside MAML files. These can be used to document the author of the MAML file, describe the functions that certain elements perform in MAML files, contain version-control information, or describe any other desired information. Comments may or may not be sent to the rendered MAML files, as desired. The form of the <comment> tag is as follows:

<comment {display=“true|false”}>

The “display” attribute is optional and determines whether or not the comment is to be sent to the requesting device or stripped out during the MAML transformation process. If the value for the “display” attribute is “true” the comment will be sent to the requesting communication device 202 and will be viewable if the requesting communication device user looks at the source code of the rendered file. If the value for the “display” attribute is false, the comment will be stripped out of the MAML file during the transformation process. If the “display” attribute is not specified, the default is false.

The actual comment text is placed between the <comment> and </comment> tags.

The following example would place the comment in the source code of the transformed MAML document. If users look at the source code of the transformed MAML document they would see the comment described above. The “&#xa” text shown below is an XML entity that forces a line break in the rendered comment on the requesting communication device 202.

### EXAMPLE 1

<comment display=“true”>
File: test.maml &#xa;
Author: Author Name &#xa;
</comment>

Tag: <em>

The <em> tag contains text that should be emphasized or drawn attention to in some way, dependent on the current communication device 202. Communication devices 202 that cannot display emphasized text simply display the contained text normally. The <em> tag does not support any attributes, instead, <em> and </em> is placed around text that should be emphasized.

The following example of use of the <em> tag displays normal text, followed by emphasized text, followed by additional text rendered normally.

### EXAMPLE 1

<p>Here is some normal text.
<em>This text is emphasized! Important!</em>
Here is some un-emphasized text.
</p>

Tag: <font>

The <font> tag supports the rendering of text with different fonts, sizes, and colors. Most WML-based devices will ignore this tag, rendering the text inside the tags normally. The form of the <font> tag is as follows:

<form face=“fontname1{,fontname2,fontnamex}” size=“fontsize” color=“fontcolor”>

The “face” attribute, which is optional, specifies a font name in which to render the contained text. For most <font> supported devices, multiple fonts can be placed inside this attribute value, separated by commas. If the rendering browser cannot render using the first font, it will attempt to render text using the second font, followed by succeeding fonts in the comma-delimited list.

The “size” attribute, which is optional, specifies a size in which to render the contained text. Either integer values or relative values may be used. In addition, the “color” attribute, which is optional, specifies a color in which to render the contained text. Some devices support named colors, such as “red” or “blue.” For maximum compatibility, hexadecimal RGB color values are recommended.

The following example renders text in an assortment of fonts and sizes.

### EXAMPLE 1

<p>
<font color=“red”>Font color is red.</font>
<br/>
<font color=“#FF0000”>This should also be red.</font>
<br/>
<font face=“Times New Roman”>Font face is Times New Roman.</font>
<br/>
<font face=“Arial”>Font face is Arial.</font>
<br/>
<font face=“Verdana,Arial”>This text could use one of two fonts.</font>
<br/>
<font size=“3”>Font size is 3.</font>
<br/>
<font size=“−1”>Font size is one less than the normal font size.
</font>
</p>

Tag: <form>

The <form> tag is a container tag designating a user-input form in a MAML file. It also inserts a paragraph break in the current MAML file. The format for this tag is as follows:

<form method=“get|post” action=“maml_file” {ext=“true”} {title=“form_title”}>

The “method” attribute signifies the HTTP method that will be called when processing this form, namely, either “get” or “post.” Either method may be selected for handling forms. By utilizing the “get method,” form attributes will be viewable, though somewhat encoded, in the URL location line.

The “action” attribute signifies the file or URL that will be accessed as soon as the user submits the form. This page should give the user notification that the form was submitted correctly, and it may also perform processing depending on the data contained.

The “ext” attribute, which is optional, may either be ignored or it may have a “true” value. If the action of the “form” attribute is to a MAML file on the current universal server 222, the attribute “ext” and value is ignored. If, however, a form on another server is going to process the form data, then the attribute “ext” should have a value of “true”.

The “title” attribute, which is optional, provides a title that may be displayed in the form of <form> elements. Some devices may ignore this attribute. The following example sets up a form that will be processed using an HTTP “post” method (discussed further hereinbelow). When the user submits the form data, which are contained in input elements between the <form> and </form> tags, the universal server 222 directs the user to the processform.maml page for further processing. This form has a title of “Input Your Password” which may be displayed on some devices. Since the attribute “ext” does not exist in this example, it is assumed that the form will be processed using the same server (or server farm) that contained the original MAML form.

### EXAMPLE 1

<form method=“post” action=“processform.maml” title=“Input Your Password”>

. . .

</form>

Tag: <free-form>

The <free-form> tag contains valid XML that may not follow the MAML specification. This tag can be used to include raw HTML, WML, or other XML-compliant data that will not get transformed using the device manager 225. Preferably, although this tag contains raw code that will be sent straight to the client browser, this code should be valid XML format. Tags either have closing tags or are self-closing, illegal characters are not used unless escaped or replaced with valid entities. The tag comprises no attributes, instead, free-form valid XML is inserted inside the <free-form> and </free-form> tags.

The following example displays a sample weather report, displaying the high and low temperatures for the day inside a table. It should be noted that since MAML does not directly support tables or the <i> tag (discussed hereinbelow), the <free-form> tag is used to insert the table and italicized text into the rendered MAML document.

### EXAMPLE 1

<free-form>

<table columns=“2”>

<tr>

<td>
<i>High</i>
</td>
<td>
<i>Low<i>
</td>

</tr>
<tr>

<td>53</td>
<td>42</td>

</tr>

</table>
</free-form>

Tag: <help>

The <help> tag allows rendered MAML documents to contain a link to help information, either in the form of a hyperlink or a softkey button. This help information may be provided on a secondary MAML page that desires help information. The format of for the <help> tag follows:

<help src=“URL” {ext=“true”}>

The “src” attribute is the URL to the page that contains the help information. In addition, text or images contained between the opening <help> tag and the closing </help> tag will be displayed as the help description.

The “ext” attribute, which is optional, determines whether or not the hyperlink is to a MAML file on the current universal server 222, or to a file on another server. The “ext” attribute is set to “true” if the destination of the link is another server. Otherwise, the “ext” attribute is left out.

The following example renders a page with a <help> tag. The <help> tag is described with the word “Help.” Accessing the help tag takes the user to the MAML file info.maml.

### EXAMPLE 1

<?xml version=“1.0” encoding=“UTF-8”?>
<MAML vers=“2.0”>

<page id=“help” title=“Help”>

<p>This is a page with a help tag.</p>
<help src=“info.maml”>Help</help>
<a href=“fontSize.maml”>Next</a>

</page>

</MAML>

Tag: <hiddeninput>

The <hiddeninput> tag supports the addition of form parameters that remain hidden to the user. Users normally cannot see or change these parameters without looking at the source code of the rendered MAML document. The format for the <hiddeninput> tag is as follows:

<hiddeninput name=“parameter_name” value=“parameter_value”>

The “name” attribute provides this form element with a name so that when form elements are retrieved through scripts this particular element can be identified. In addition, the “value” attribute provides the value that will be associated with the parameter name designated by the “name” attribute. The <hiddeninput> parameters can be seen by looking at the source code of device-friendly rendered MAML pages.

The following example is taken from a search application. The user is prompted to enter in their query; this information will be placed in a “query” parameter. The form will also contain a “searchtype” parameter with the value “basic.” When the form is submitted, the “queryresult.maml” page, can determine that the type of search performed was a basic search based on the value of the “searchtype” parameter.

<form method=“get” action=“queryresult.maml”>
<textbox name=“query” lines=“1” maxlength=“40” size=“20”
caption=“Enter your
search query.” />
<hiddeninput name=“searchtype” value=“basic”>
<button type=“submit” caption=“Submit” />
<button type=“reset” caption=“Reset” />
</form>

Tag: <hr>

The <hr> tag renders a horizontal line or a line of dashes. Most of the time, the <hr> tag is a self-closing tag and is written as such: <hr />. The <hr> tag, however, has one attribute that some browsers support, namely, a width attribute. The format of the <hr> tag is as follows:

<hr {width=“number|percentage of screen width”}>

The “width attribute, which is optional, renders a horizontal line with a certain pixel or percentage width. The following example displays a line of text, a horizontal line taking up fifty percent (50%) of the screen width, another line of text, a horizontal line taking up the full screen width, and another line of text.

### EXAMPLE 1

<p>Here is some text.
<hr width=“50%” />
This text is underneath a horizontal line.
<hr />
This text is underneath another line.
</p>

Tag: <img>

The <img> tag is used to render images in MAML files. Not all devices support the <img> tag. This is due to the communication device 202 capabilities. These devices 202 may either ignore the <img> tag altogether or render the text provided in the “alt” attribute (discussed below). These graphic files can be located in any directory such as, but not limited to, a directory within the server memory 227. Preferably they are placed in the same directory as the calling MAML file or a subdirectory. Similar to <br>, the <img> tag may be self-closing.

The <img> tag may have multiple attributes that allow control of image position, size, mouseover text, and margins. Attribute support may also vary from communication device to communication device 202. The format of the <img> tag is as follows:

<img src=“file {NO EXTENSION!}” {alt=“text”}
{align=“default | left | center | right |
top | bottom | middle”} {width=“###”}
{height=“###”} {hspace=“###”}
{vspace=“###”} {border=“###”}>

The “src” attribute points to the group of source files containing the image that is to be displayed. This URL preferably contains the graphic image name, but not the extensions. The “alt” attribute determines alternative text displayed either while the image is loading, or in the case that the requesting device does not support images, in place of the actual graphic.

The “align” attribute, which is optional, determines how the image will be displayed on the page—either in a “default” manner (kept with the text), or in a “floating” alignment to the left of the text, in the center, to the right, to the top, to the bottom, or in the middle of the text.

The “width” attribute, which is optional, specifies the width of the image. This can be used to render images with different widths than they are in the actual files. Also, some browsers may render a page more quickly if given the original width of the image. This way, the browser can allot room for the image before it actually loads and displays the image file.

The “height” attribute, which is optional, specifies the height of the image. This can be used to render images with different heights than they are in the actual files. In addition, the “hspace” attribute, which is also optional, specifies how closely or tightly other MAML elements should appear next to the image horizontally. The higher the value of the “hspace” attribute, the larger the horizontal margin is between the image and other surrounding elements.

The “vspace” attribute, which is optional, specifies how closely or tightly other MAML elements should appear next to the image vertically. The higher the value of the attribute, the larger the vertical margin is between the image and surrounding elements.

Finally, the “border” attribute specifies whether or not the image should have a border if the image is to act as a hyperlink. If the “border” value is 0, no border will be displayed.

The larger the value, the greater the size of the border. Note that the default value varies depending on the communication device 202 capabilities.

The following example renders an image named “Phone.” If the image fails to render, or while the image is loading, the text “Phone image” will be displayed.

### EXAMPLE 1

<img src=“phone” alt=“Phone image”/>

The following second example renders a hyperlink to the file home.maml. Instead of displaying text in the hyperlink, an image logo is displayed, surrounded by a border. If the image fails to render, or while the image is loading, the text “Home” will be displayed. Since not every browser supports images, it is highly recommended that if an image is to be placed as a hyperlink, a description of the page to which the image links should be placed in the “alt” attribute.

### EXAMPLE 2

<a href=“home.maml”>
<img src=“logo” alt=“Home” border=“1” />
</a>

The following third example renders an image labeled “hello.” If the image fails to render, or while the image is loading, the text “Hello, World!” should be displayed. The image is forced to have a width of 60 pixels and a height of 50 pixels, even if the original image has a different width and height. The image is also aligned left, and has five pixels margin horizontally and ten pixels margin vertically between it and other rendered MAML elements.

### EXAMPLE 3

<img src=“hello” alt=“Hello, World!” width=“60”
height=“50” align=“left” hspace=“5” vspace=“10” />

Tag: <import>

The <import> tag, which is a companion tag to the <script> tag (described below), allows specification of additional Java import paths for use while the server engine 226 is processing the page request. This adds flexibility to scripts in that access may be provided to Java database connectivity (JDBC) objects, common Java utilities, and external business objects.

Preferably, one <import> tag is utilized per MAML page and it resides prior to the first <script> tag. Preferably, the <import> tag resides after the <MAML> tag and before the first <page> tag, both of which are discussed in detail below. The <import> tag does not have attributes. In addition, it should be noted that Java import paths should be placed inside the opening and closing tags. The format for importing in additional Java classes is as follows:

### EXAMPLE 1

<import>
import CLASSES_OR_PACKAGES_TO_IMPORT;
import OPTIONAL_MORE_CLASSES_OR_PACKAGES_{—}
TO_IMPORT;
</import>

The number of of Java imports inside the <import> tag need not be limited. The syntax, however, should be correct Java syntax. It should be noted that the Java language does not allow specification of an import path that contains no files inside. If a specified path contains no valid class files, the MAML page will not compile correctly. Also, in accordance with this first example, a 500 error will be sent to the browser and an error will be recorded in an error log.

The following second example imports all of the classes in the Java utility package, making them accessible in your MAML scripts.

### EXAMPLE 2

<import>import java.util.*;</import>

Tag: <li>

The <li> tag, when used inside a list element of a <form> tag, signifies one of the items from which a user may choose inside a selection list. Inside the <li> and </li> tags can be any text that describes the selection list item. The format of the <li> tag is as follows:

<li value=“list_item_value” {vfile=“filenam”}> list item</li>

The “value” attribute signifies the value that the selection list will contain if this particular list item is selected. It is recommended to make this value as small as possible to avoid blowing the WAP stack.

The “vfile” attribute, which is optional, signifies that the <li> tag should playback audio from a file. The value of this attribute should be the filename that contains the audio to be played.

The following example provides a selection list that allows users to select from one of the following music styles: “blues,” “country,” “jazz,” “rock,” or “r&b.” Choosing one of these list items places one of the following values in the “music” parameter: “b,” “c,” “j,” “r,” or “n,” respectively.

### EXAMPLE 1

<list display=“select” name=“music” title=“Music choice?”
form=“true” lines=“2”>

<li value=“b”>Blues</li>
<li value=“c”>Country</li>
<li value=“j”>Jazz</li>
<li value=“r”>Rock</li>
<li value=“n”>R&B</li>

</list>

The following second example provides a selection list that allows users to select multiple books from the book list: “Call of the Wild,” “Huckleberry Finn,” “The Hound of the Baskervilles,” “The Grapes of Wrath,” “Tom Sawyer,” and “White Fang.” Choosing these items puts one or multiple of the following values in the book parameter: “cw,” “hf,” “hb,” “gw,” “ts,” and/or “wf,” respectively.

### EXAMPLE 2

<list display=“combo” name=“book” title=“Purchase which books?”
form=“true”
lines=“3”>

<li value=“cw”>Call of the Wild</li>
<li value=“hf”>Huckleberry Finn</li>
<li value=“hb”>The Hound of the Baskervilles</li>
<li value=“gw”>The Grapes of Wrath</li>
<li value=“ts”>Tom Sawyer”></li>
<li value=“wf”>White Fang</li>

</list>

Tag <list>

The <list> tag surrounds a list of information. For use inside the <form> tag, the <list> tag has two purposes. First, the <list> tag surrounds a list of menu items from which a user can make choices. Second, the <list> tag determines the selection list type, its name, and performs other key features.

Within forms, the format of the <list> tag is as follows:

<list name=“element_name” form=“true” display=“select | combo”
{title=“form_title”}
{lines=“number_of_lines_to_display”}
{tabindex=“tabindex_number”}
{enumerate=“true | false”}>

The “name” attribute provides this form element with a name so that when form elements are retrieved through scripts, this particular element can be identified. The <form> attribute preferably has a value of true to differentiate select lists found in<form> tags from menu options or displayable lists not found in<form> tags.

The “display” attribute determines how the selection list will be displayed and how many items can be selected from a list. If the value is “select,” only one item may be selected from the list. Alternatively, if the value is “combo,” multiple items may be selected from the list at once. For forms, the “display” attribute is preferably required.

The “title” attribute provides a title for the section list. Depending on device characteristics, this text may be placed on top of the selection list. For communication devices 202 that split multiple input elements into separate pages, this text is used as the title of a link that takes the user of the communication device 202 to the selection list.

The “lines” attribute, which is optional, for the communication devices 202 that support this attribute, signifies the number of selection list items that are to be visible at one time. For devices that support the <list> and render selection lists as pick-lists, a scrollable pick-list is rendered and this number of selection items will be visible without scrolling through the pick-list.

The “tabindex” attribute, which is optional, for those browsers that support this attribute, signifies the tab order of this selection list in a multi-selection list or multi-input-field form. A value of 1 means that pressing the tab one time should bring the user to this element. A value of 2 means that pressing the tab again from the first input element should bring the user to this second input element, etc.

The “enumerate” attribute, which is optional, is preferably for voice applications. If the “enumerate” attribute does not exist in a voice attribute, or if it exists and is set to a value of “true,” the list of menu items will be read to the user. If this attribute exists and is set to “false,” the list of menu items will not be read to the user.

The following example, if placed in a <form> element, would render a selection list that would be identified with the name “music.” The title text “Music choice?” may be rendered near the selection list. One item from the list may be chosen. In additional, for those devices that support the “lines” attribute, two items from the list may be displayed at once. Other devices would display all of the list items.

### EXAMPLE 1

<list display=“select” name=“music” title=“Music choice?”
form=“true” lines=“2”>
...
</list>

The following second example, if placed in a <form> element, would render a selection list that would be identified with the name “book.” The title text “Purchase which books?” may be rendered near the selection list. Multiple items from the list may be chosen concurrently. In addition, three items from the list, for those devices that support the “lines” attribute, may be displayed at once. Other devices would display all of the list items.

### EXAMPLE 2

<list display=“combo” name=“book” title=“Purchase which books?”
form=“true”
lines=“3”>
...
</list>

Outside of forms, the <list> tag is used to render a list of information. This list may contain text, images, clickable links, etc., depending on what is desired by the MAML writer and the capabilities of the devices. In the format outside of forms, the <list> tag is as follows:

<list type=“ul | ol | dl | mi” {bullet=“bulletchar”}
{name=“element_name”}
{form=“false”} {enumerate=“true | false”}
{title=“form_title”}>

The “type” attribute determines what type of list to render. To render an unordered list where each item is usually prefixed by a bullet symbol, the value “ul” is utilized. Using a value of “ol” numbers each list item. The value “dl” is used for a definition list. It should also be noted that lists may be rendered differently depending on the communication device 202.

Using the value “mi” for the “type” attribute signifies that the list should be a menu, whereby each list item is numbered and clickable. On devices that support it, menus also allow the user to press a single button to access a menu item, or they can scroll up and down through a list. <li> tags inside a <list type=“mi”> tag should comprise hyperlinks.

The “bullet” attribute determines a character that should be used as a bullet for each list item. In addition, the “name” attribute provides the <list> element with a name in which it may be later identified.

The “form” attribute should be either ignored or set to a value of “false.” This attribute determines that the rendered list is a displayable list and not a selection list inside of a <form> tag.

The enumerate attribute, which is optional, is preferably for voice applications. If this attribute does not exist in a voice attribute, or if it exists and is set to a value of “true,” the list of menu items will be read to the user. If this attribute exists and is set to a value of “false,” the list of menu items will not be read to the user.

The “title” attribute preferably is used when the “type” attribute is set to “mi.” Use of the “title” attribute provides a title for the menu. Depending on communication device 202 characteristics, this text may be placed on top of the menu. Alternatively, for communication devices 202 that split multiple input elements into separate pages, this text is used as the title of a link that takes users to the menu.

The following example number 3 renders an ordered list, wherein a number would prefix each list element. In this example, each <li> element inside the <list> tag happens to include an anchor, however, this is not a necessity.

### EXAMPLE 3

<?xml version=“1.0” encoding=“UTF-8”?>
<MAML vers=“2.0”>

<page id=“listol” title=“List ol”>

<p>This is a test for list as ol.</p>
<list type=“ol”>

<li><a href=“aInt.maml”>Anchor Int</a></li>
<li><a href=“aPage.maml”>Anchor Page</a></li>
<li><a href=“help.maml”>Help</a></li>

</list>
<a href=“listDL.maml”>Next</a>

</page>

</MAML>

The following fourth example creates an unordered, bulleted list. The first item would contain a line of text, the second item would contain hyperlinks to other MAML files, and the third hyperlink would contain a hyperlink that would call the number for Airtuit.

### EXAMPLE 4

<?xml version=“1.0” encoding=“UTF-8”?>
<MAML vers=“2.0”>

<page id=“listul” title=“List ul”>

<p>This is a test for list as ul.</p>
<list type=“ul”>

<li>Hello!</li>
<li><a href=“aPage.maml”>Anchor Page</a></li>
<li><call number=“1-865-673-9600” caption=“Airtuit”

retry=“1”/></li>

</list>
<a href=“listOL.maml”>Next</a>

</page>

</MAML>

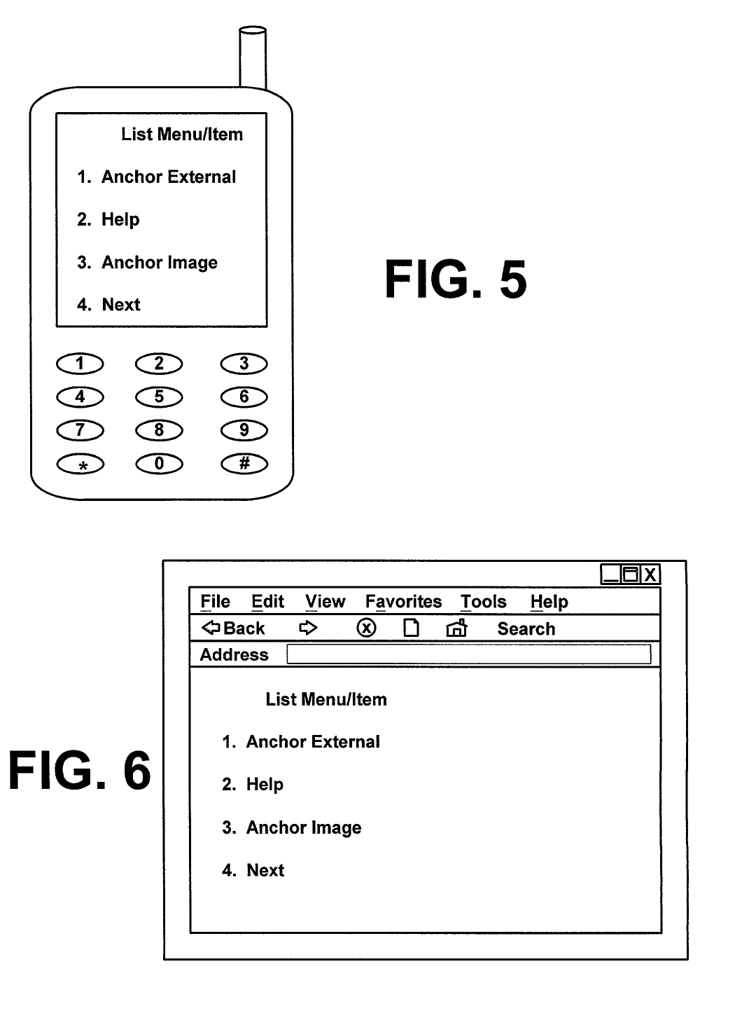

The following fifth example creates a menu. When rendered, the list items would be numbered, and clicking on a menu item via use of the communication device 202 would take users to the desired page. On some devices, users would be able to scroll through the menu or press a button to select a desired option. Examples of how this will be rendered on different devices can be seen by FIG. 5 and FIG. 6. Specifically, FIG. 5 illustrates rendering of the menu on a mobile phone, while FIG. 6 illustrates rendering on a computer screen, such as, but not limited to, a laptop.

### EXAMPLE 5

<?xml version=“1.0” encoding=“UTF-8”?>
<MAML vers=“2.0”>

<page id=“listmi” title=“List Menu/item”>

<list type=“mi”>

<li><a href=“aExt.maml”>Anchor External</a></li>
<li><a href=“help.maml”>Help</a></li>
<li><a href=“aImage.maml”>Anchor Image</a></li>
<li><a href=“varSet.maml”>Next</a></li>

</list>

</page>

</MAML>

Tag: <MAML>

The <MAML> tag is the root of the MAML document. Preferably, this is the only uppercased element in MAML. The <MAML> tag is required in all MAML documents and contains <page> tags (described below). The format of the <MAML> tag is as follows:

<MAML {id=“file_id”} {title=“title_string”}
{lang=“language”} {bgcolor=“color”}
{fgcolor=“color”} vers=“MAML_version”>

The “id” attribute is a user-defined identification string for the current MAML file. This attribute may or may not be displayed on the rendered MAML page, depending on the communication device 202.

The “title” attribute, which is optional, is a user-defined string signifying the title of the current MAML file. This attribute may or may not be displayed on the rendered MAML page, depending on the communication device 202.

The “lang” attribute, which is optional, specifies the language in which text inside the current MAML file is written. In addition, the “bgcolor” attribute, which is also optional, specifies the background color for the page for communication devices 202 supporting this attribute. The color can be either a literal color name or a hexadecimal value. Of course, other methods of specifying color may also be utilized.

Alternatively, the “fgcolor” attribute specifies the default foreground, or text color for the page for devices supporting this attribute. The color can be either a color name or a hexadecimal value. Once again, other methods of specifying color may also be utilized.

The “vers” attribute specifies the MAML version to which the current document should correspond.

The following example would be placed at the beginning of a MAML document after XML identification tags. This MAML document would be identified by “newdoc” and would have a title of “new document.” The text inside the MAML document would be written using U.S. English, and the MAML document would correspond to the 2.0 specification.

### EXAMPLE 1

<MAML id=“newdoc” title=“New Document” lang=“en-US” version=“2.0”>

Tag: <nav>

The <nav> tag allows for the rendering of navigational elements between MAML pages. The format of the <nav> tag is as follows.

<nav type=“back”>

The “type” attribute determines what type of navigational element to render. Preferably, the valid value for the “type” attribute is “back,” which creates a link to the previous document on WML-based devices.

The following example renders text and a hyperlink that goes back to the previous page for MAML-based communication devices 202. All other devices would ignore this tag.

### EXAMPLE 1

<?xml version=“1.0” encoding=“UTF-8”?>
<MAML vers=“2.0”>

<page id=“navBack” title=“Nav Back”>

<p>This is a test to nav back.</p>
<nav type=“back”/>
<a href=“listUL.maml”>Next</a>

</page>

</MAML>

Tag: <p>

The <p> tag is a container tag for a paragraph of text in a MAML file. It may also be used to insert a paragraph break in the current MAML file. Certain communication devices support an extended <p> tag and may use some of the attributes illustrated hereinbelow by the general format of the <p> tag.

<p {wrap=“true|false”} {align=“left|center|right|justify”} {vfile=“filename”}>

The “wrap” attribute, which is optional, signifies whether or not text within the <p> tag should word-wrap or not. Preferably, the default value for the “wrap” attribute is “false.” This may not be supported by the client browser.

The “align” attribute, which is also optional, signifies whether the text alignment inside the <p> tag is aligned to the left, center, right, or justified. This feature may not be supported by the client browser.

The “vfile” attribute, which is optional, signifies that the <p> tag should playback audio from a file. The value of the “vfile” attribute should be the filename that contains the audio to be played. This attribute is supported if a client accesses the universal server through a supported voice portal.

The following example displays a line of right-aligned text, followed by a centered line of text.

### EXAMPLE 1

<p align=“right”>
This text may be aligned right in some devices.
</p>
<p align=“center”>
This text may be centered in some devices.
</p>

Tag: <page>

The <page> tag signifies distinct sections inside a MAML document. Pages may either be rendered pages (for WML-based communication devices 202) or sections of a larger page (for some HTML-based communication devices 202). The format of the <page> tag is as follows:

<page id=“identification” title=“page_title” {vfile=“filename”}>

The “id” attribute is a user-defined identification string. This attribute, in combination with the <page> tag, is used to allow hyperlinks inside one MAML file to jump between pages. In addition, the “title” attribute is a user-defined title for the current page.

The “vfile” attribute, which is optional, signifies that this tag should playback audio from a file. The value of this attribute should be the filename that contains the audio to be played.

The following example designates the start of a new page inside a MAML file. The page would be identified by the string p1 and have a title of “Welcome!”

### EXAMPLE 1

<page id=“p1” title=“Welcome!”>

Tag: <postvar>

The <postvar> tag allows for the attaching of parameters onto the ends of <a href> and <help> hyperlinks. This causes desired parameters to be set whenever the <a href> or <help> tag is clicked. The <postvar> tag is self-closing, and is preferably used inside <a href> and <help> tags. The format for the <postvar> tag is as follows.

<postvar name=“parameter_name” value=“parameter_value”/>

The “name” attribute determines the name of the parameter that should be set when/if the enclosing hyperlink is clicked. In addition, the “value” attribute determines the value that the name parameter should be set to when/if the enclosing hyperlink is clicked.

The following example renders a hyperlink labeled “Go to the next page.” When the hyperlink is clicked, the user is taken to nextpage.maml and the parameter “referrer” is set to the value “menu.”

### EXAMPLE 1

<a href=“nextpage.maml’>Go to the next page
<postvar name=“referer” value=“menu” />
</a>

Preferably, the <postvar> tag is used on devices that support page decks (i.e., WML browsers). The following example illustrates this preference by attempting to post a parameter from one page in a MAML file to another. This example works as expected with WML browsers, showing the passed parameter.

### EXAMPLE 2

<?xml version=“1.0” encoding=“UTF-8”?>
<MAML vers=“2.0”>

<page id=“p1” title=“First page”>

<a href=“#p2”>Go to second page

<postvar name=“v1” value=“xyz”/>

</a>

</page>
<page id=“p2” title=“Second page”>

Does postvar get posted:<br/>
<script>

response.write(request.getParameter(“v1”));

</script>

</page>

</MAML>

Tag: <script>

The <script> tag enables the developer of the MAML page to create dynamic MAML content on the server side. It also allows programmers to process business logic on the server side. The <script> tag can be placed anywhere inside the root <MAML> node of a MAML file. Java code may be placed inside the opening and closing tags of the <script> tag. Specifically, the format of the <script> file is as follows:

<script>
{Java Code goes here... }
</script>

MAML files may contain multiple <script> </script> blocks. These script blocks are processed in a top-down approach. The first <script> block encountered in processing the MAML page is the first script to run. Also, a <script> block further down the page can reference variables defined in an earlier script. It is even possible to start a script iteration in one <script> block and close it in another <script> block below (this is explained below in an example).

MAML <script> blocks can either return nothing (if they are processing logic), or they can return valid MAML code. MAML code returned from <script> blocks should be well formed, or they should open or close tags that are properly closed or opened by other parts of the MAML file. As an example, if a MAML script is placed inside a <page> tag and it plans on outputting the rest of the MAML for its parent MAML file (this scenario can happen by a <script> block being the last code in a given MAML file or by a <script>block issuing the Java “return( )” statement, thus halting the execution of the remaining of the MAML file), the script closes the remaining open MAML tags such as</page> and </MAML>. Failure to do this results in a 500 error being returned to the requesting browser and an error being sent to the error log.

As MAML scripts execute, in order to return MAML code back to the original MAML files so the MAML script responses can be displayed, the following format should be used.

response.write(“text_to_retum”)

The following example, when placed inside a MAML file, outputs a new paragraph and the text “Demonstration MAML Script.”

### EXAMPLE 1

<script>
response.write(“<p>Demonstartion MAML Script</p>”);
</script>

In accordance with the following, second example, iteration.maml, notice that a “for” loop starts in one <script> block yet ends in another <script> block. This example outputs the text “Hello” and “went in iteration” twice.

### EXAMPLE 2

<?xml version=“1.0” encoding=“UTF-8”?>
<MAML vers=“2.0” title=“Iteration Test”>

<page id=“p1” title=Page 1”>

<script>

int i;
for (i=1;i<3;i++)
{

</script>
<p>Hello</p>
<script>

response.write(“went in iteration”);

}

</script>

</page>

</MAML>

Tag: <setvar>

The <setvar> tag allows for MAML files to directly modify the internal variables used on client communication devices 202. A common use is for clearing default values. For example, when a <textbox> tag (described below) is used on an OpenWave Phone.Com (UP) devices, if a previously used <textbox> resulted in the user entering information, that old information will be placed as the default value in the new textbox. By using the <setvar> tag, this value can be cleared for the new textbox. The format of the <setvar> tag is as follows:

<setvar name=“variable name” value=“variable value”>

The “name” attribute determines the name of the variable on the client communication device that will be modified. In addition, the “value” attribute determines the value to which to set the designated client-side variable. The value of “ ” is supported.

In the following example, a menu list is rendered. The only option in this rendered list is to access the login page login.maml. If this option is selected, the value of the variable “login” is set to “ ”. Afterwards, login.maml would be accessed.

### EXAMPLE 1

<list type=“mi”>

<li>

<a href=“login.maml”>Login<setvar name=“login”
value=“”/></a>

</li>

</list>

Tag <speak>

The <speak> tag allows for MAML files to render text that is specific to a voice application. Text inside this tag will be spoken, but the text will not be rendered to non-voice adapters. The tag syntax is simply the <speak> tag, text that needs to be spoken, and the closing </speak> tag. If, instead of rendering text, audio needs to be played back from a file, the “vfile” attribute should be used.

The following example speaks the text “How are you doing today?” It should be noted, however, that the text is not rendered on non-voice devices. Example 1

<speak>
How are you doing today?
</speak>

Tag: <strong>

The <strong> tag comprises text that should be rendered bold or drawn attention to in some way, dependent on the current communication device. Devices that cannot display bolded text will simply display the contained text normally. Examples of different ways to draw attention to text may include, but is not limited to, blinking text, fading text in and out, changing text font and changing text size. Use of the <strong> attribute may be performed by placing <strong> and </strong> around the text that should be emphasized.

The following example displays normal text, followed by bolded text, followed by a sentence rendered normally.

### EXAMPLE 1

<p>Here is some normal text.
<strong>This text is bolded! Important!</strong>
Here is some normal text.
</p>

Tag: <symbol>

The <symbol> tag is used to render certain types of symbols on rendered MAML pages. Certain characters would not pass through the transformation process quickly without this tag. The format for use of the <symbol> tag is as follows:

<symbol value=“$|%|amp|copy|tm|r”>

The “value” attribute determines which type of symbol to render on the transformed MAML page. This can either be a dollar sign ($), a percent (%), an ampersand (&), a copyright symbol (©), a trademark symbol (™), or a registered trademark symbol (®). Of course, other symbols may also be rendered. Note that, depending on device capabilities, some symbols may be rendered differently than how they are presented herein.

The following example displays a list of symbols available using the <symbol> tag.

### EXAMPLE 1

<?xml version=“1.0” encoding=“UTF-8”?>
<MAML vers=“2.0”>

<page id=“Symbol” title=“Symbol List”>

<p>This is a list of symbols available.</p>
<symbol value=“$”/><br/>
<symbol value=“%”/><br/>
<symbol value=“amp”/><br/>
<symbol value=“copy”/><br/>
<symbol value=“tm”/><br/>
<symbol value=“r”/><br/>
<a href=“help.maml”>Next</a>

</page>

</MAML>

Tag: <textbox>

The <textbox> tag allows users to input free form data inside a textbox within a form. This information may be anything. The <textbox> tag also supports the entering of password information where asterisks are returned to the user. The format of the <textbox> tag is as follows:

<textbox name=“attribute_name” {caption=“default_caption”}
{default=“default_value”} {password=“true | false”}
{format=“wml_format”}
{readonly=“true | false”} {lines=“number_of_line”}
{maxlength=“maxlength_of_field”}
{size=“displayed_textbox_size”}
{accesskey=“button_or_key”}
{tabindex=“tabindex_number”}
{emptyok=“true |
false”} {grammer=“digits|boolean”} {vrecord=“true”}
{savemessage=“message_to_read”} {recordagain=“pagelink”}
{mainmenupath=“pagelink”}>

The “name” attribute provides this form element with a name so that when form elements are retrieved through scripts this particular element can be identified. In addition, the “caption” attribute provides a text caption that may be displayed next to the textbox. This caption is preferably short and lets the user know what kind of information they are expected to input.

The “default” attribute, which is optional, comprises the default value of the textbox. If the user does not enter anything extra in the textbox, this will be sent through the form. The user, however, will have the option of deleting this information from the textbox unless the textbox contains the attribute “readonly=true” and the rendering device supports this attribute.

The “password” attribute, which is optional, signifies whether or not the textbox is to be a password entry field. If the value is “true,” entered text is shown as asterisks. If the value is “false,” the actual data that the user enters in is displayed in the textbox. The default is “false.”

The “format” attribute, which is optional, provides an input mask for information users type into the textbox. The “format” attribute forces certain types of input on certain communication devices 202, mainly WML-based devices. For communication devices 202 that do not support this attribute, such as HTML-based devices, this input restriction is ignored.

The input mask may comprise of the following:

| | |
|---|---|
| A | Any upper-case, non-numeric character (including punctuation) |
| a | Any lower-case, non-numeric character (including punctuation) |
| X | Any upper-case letter |
| x | Any lower-case letter |
| N | Any numeric character |
| M | Any character, assuming the user will input uppercase but |
| | allowing any character |
| M | Any character, assuming the user will input lowercase but |
| | allowing any character |
| *f | Any number of characters of one of the above type, replacing |
| | ‘f’ with the formatting. For example, *X would allow |
| | the input of any number of upper-case letters. |
| Nf | 1-9 characters of one of the above types, replacing |
| | ‘n’ with a number from 1-9 and replacing ‘f’ |
| | with the type of formatting. For example, 3N would allow the |
| | entry of three numbers, and 8x would allow the entry of up |
| | eight lower-case letters. On some WML implementation, 3N |
| | would allow the entry of up to three numbers, and on some |
| | implementations, the same masks requires the entry of |
| | exactly three numbers. |
| \c | Forces the textbox to contain a character in the input string. |
| | Replace c with the character that you want displayed. For example, |
| | \[5x\] would display two brackets and allow the user |
| | to input five lower-case letters in between. |

The “readonly” attribute specifies whether or not the textbox is read-only, for devices that support this feature. If the value is “true,” the default value of the textbox is displayed and the user cannot change this value. If the value is “false,” the user can change the value. The “readonly” attribute is ignored in browsers. It is possible that using this attribute might cause textboxes that were thought to be read-only to become editable with people using other browsers.

When considering whether to use the “readonly” attribute, the following optional implementation variances may be considered, namely, “lines,” “maxlength,” “size,” “accesskey,” “tabindex,” “emptyok,” “grammer,” “vrecord,” “savemessage,” “recordagain,” and “mainmenupath.”

The “lines” attribute, which is supported by most HTML-style browsers, signifies the number of lines that should be displayed in a textbox entry field. Browsers that do not support this attribute render single-line textboxes. In addition, The “maxlength” attribute, which is supported by most HTML-style browsers, signifies the maximum number of characters that can be entered into a textbox. If a browser supports the maxlength attribute, it typically does not support the “format” attribute, and vice-versa. This allows browsers that do not support the “format” style input masking to have some measure of input restriction.

The “size” attribute limits the rendered size of the textbox if the textbox is one line (default) or multi-line, if the attribute “lines” is greater than one on devices that fully support the “lines” attribute. Some devices will ignore values of the “size” attribute if they are below a certain length.

The “accesskey” attribute signifies a shortcut key that users can enter to quickly access a given textbox on a form containing more than one textbox or other input element. In addition, the “tabindex” attribute signifies the tab order of this textbox in a multi-textbox or multi-input-field form. A value of 1 means that pressing the tab one time should bring the user to this element. Alternatively, a value of 2 means that pressing the tab again from the first input element should bring the user to this second input element, etc.

The “emptyok” attribute signifies whether or not a given textbox can be empty. If the value is “true,” then it is assumed that this textbox can be empty. If, however, the value is “false,” then it is assumed that the textbox must not be empty.

The “grammar” attribute is for voice applications. This attribute determines the type of input to be expected from the <textbox>. If the attribute is “digits,” the <textbox> assumes to receive numeric input. If the attribute is “boolean,” the <textbox> assumes to receive the input of “yes” or “no.”

The “vrecord” attribute is for voice applications, and supports the value “true.”

When used, this attribute determines that the input of the user will be recorded to a file and posted to the URL specified in the “action” attribute of the surrounding <form> tag. When using this attribute, it is highly recommended to include the attributes “savemessage,” “recordagain,” and “mainmenupath.”

The “savemessage” attribute is for voice applications. The value should be a string and is the text message that will be read to the user while the voice file is saved. In addition, The “recordagain” attribute is also for voice applications. The value should be a URL that contains the link of a page that the universal server 222 will go to if the user decides that they want to re-record their message. Finally, the “mainmenupath” attribute is also for voice applications. The value should be a URL that contains the link of a page that the universal server 222 will go to if the user decides that they want to go back to the main menu.

The following example renders a textbox that will be identified by “userid.” In addition, the user will be prompted by the text “User id?” Depending on the device capabilities, the user will be able to enter in up to five lower-case letters, up to five of any character, or may be forced to enter in five lower-case letters. The textbox should not be empty when the user is done entering information. The textbox should be five characters wide and one line deep. In addition, its tab-index is one.

### EXAMPLE 1

<textbox name=“userid” caption=“User id”?”
format=“5x” readonly=“false”
lines=“1” emptyok=“false” maxlength=“5” size=“5”
tabindex=“1” />

The following second example renders a textbox that will be identified by “pwd.”The user will be prompted by the text “Password?” The user will be able to enter in up to nine characters (on some devices, mainly HTML devices) or any number of characters on some devices. When entering in a password, asterisks will be returned to the user. This textbox should not be empty when the user is done entering information. The textbox should be nine characters wide and one line deep (default). In addition, its tab-index is two.

### EXAMPLE 2

<textbox name=“pwd” caption=“Password?” password=“true” readonly=“false”
emptyok=“false” maxlength=“9” size=“9” tabindex=“2”/>

The following third example renders a textbox that will be identified by “book.”The user will be prompted by the text “Favorite Book?” In addition, the user will be able to enter in up to virtually any number of characters. The textbox itself can be empty when the user is done entering information. This textbox should be twenty characters wide and, for devices that support it, two lines deep. In addition, its tab-index is three.

### EXAMPLE 3

<textbox name=“book” caption=“Favorite Book?” password=“false” format=“*m”
lines=“2” emptyok=“true” readonly=“false” size=“20” tabindex=“3”/>

It is also important to make an application robust and secure. Due to the open nature of the Internet, without proper checks, unscrupulous users can access files to which they normally would not be given express rights. Therefore, in accordance with an alternate embodiment of the invention security measures are provided by the present access system.

In accordance with this alternate embodiment of the invention, a user, or client, is required to use a secure protocol for accessing information from a server. Specifically, the https:// protocol, otherwise referred to as the secure http, is required so that usernames and passwords are not stolen over the Internet. The https:// protocol is also required to be used for accessing secure applications so that additional validation is required before access is provided to sensitive materials. Secure http is a secure message-oriented communications protocol designed for use in conjunction with http, and therefore is similar to the http:// protocol.

Secure http provides a variety of security mechanisms to http clients and servers, providing security service options appropriate to the wide range of potential end uses possible for the World-Wide Web. The protocol provides symmetric capabilities to both client and server (in that equal treatment is given to both requests and replies, as well as for the preferences of both parties) while preserving the transaction model and implementation characteristics of http.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A system for providing universal mobile device access to information, comprising:
an enterprise backend having said information stored therein; and
a universal server connected to said enterprise backend for receiving a request for said information from said mobile device, and for providing said mobile device with said information from said enterprise backend, wherein said universal server does not require separate software applications to customize display of said information for each different category of mobile device requesting said information.

2. The system of claim 1, further comprising a business object memory that defines a manner of retrieving said requested information from said enterprise backend.

3. The system of claim 1, wherein said universal server further comprises:
a server transceiver for determining a category of said mobile device; and
a device manager having style sheets therein, wherein each of said style sheets identifies a category of mobile device and display properties of said mobile device that pertain to said category.

4. The system of claim 3, wherein said determining a category of said mobile device is performed by the steps of:
receiving a data packet from said mobile device requesting said information; and
extracting a header portion from said received data packet, wherein said header portion identifies said category of said mobile device.

5. The system of claim 3, wherein each of said display properties within said category is determined in response to said request for information, said display properties being received from said enterprise backend.

6. The system of claim 3, wherein said display properties include at least one of the following: screen size, refresh rate or character style.

7. The system of claim 1, wherein said requested information is provided to said requesting mobile device in a format displayable by said mobile device, so that a user of said mobile device may view said requested information via said mobile device.

8. The system of claim 7, wherein said providing requested information to said requesting mobile device in a format displayable by said mobile device is performed by utilizing a mobile application markup language to format said requested information to be presented in accordance with a predefined layout specific to said category of said requesting mobile device.

9. A method of providing universal mobile device access to information, comprising the steps of:
receiving a request for said information from a mobile device; and
providing said mobile device with said information, wherein said providing of said information does not require separate software applications for each different category of mobile device requesting said information, to customize display of said information.

10. The method of claim 9, further comprising the steps of:
determining a category of said mobile device; and
determining display properties of said mobile device that pertain to said category.

11. The method of claim 10, wherein said step of determining a category of said mobile device, further comprises the steps of:
receiving a data packet from said mobile device requesting said information; and
extracting a header portion from said received data packet, wherein said header portion identifies said category of said mobile device.

12. The method of claim 10, wherein each of said display properties within said category is determined in response to said request for information, said display properties being received from an enterprise backend.

13. The method of claim 10, wherein said display properties include at least one of the following: screen size, refresh rate or character style.

14. The method of claim 9, wherein said requested information is provided to said requesting mobile device in a format displayable by said mobile device, so that a user of said mobile device may view said requested information via said mobile device.

15. The method of claim 14, wherein said step of providing requested information to said requesting mobile device in a format displayable by said mobile device is performed by utilizing a mobile application markup language to format said requested information to be presented in accordance with a predefined layout specific to said category of said requesting mobile device.

16. A system for providing universal mobile device access to information, comprising:
means for receiving a request for said information from a mobile device; and
means for providing said mobile device with said information, wherein providing of said information does not require separate software applications for each different category of mobile device requesting said information, to customize display of said information.

17. The system of claim 16, further comprising:
means for determining a category of said mobile device; and
means for determining display properties of said mobile device that pertain to said category.

18. The system of claim 17, wherein each of said display properties within said category is determined in response to said request for information, said display properties being received from an enterprise backend.

19. The system of claim 17, wherein said display properties include at least one of the following: screen-size, refresh rate or character style.

20. The system of claim 16, wherein said requested information is provided to said requesting mobile device in a format displayable by said requesting mobile device, so that a user of said mobile device may view said requested information via said mobile device.

21. The system of claim 20, wherein said means for providing requested information to said requesting mobile device in a format displayable by said requesting mobile device, utilizes a mobile application markup language to format said requested information to be presented in accordance with a predefined layout specific to said category of said requesting mobile device.
